(19) United States
(12) Patent Application Publication
(10) Pub. No.: US 2014/0065304 A1
(43) Pub. Date: Mar. 6, 2014

(54) METHOD FOR MANUFACTURING LONG LAMINATE FILM

(71) Applicant: Nitto Denko Corporation, Ibaraki-Shi Osaka (JP)

(72) Inventors: Shoichi Matsuda, Ibaraki-shi (JP); Yoshiaki Asanoi, Ibaraki-shi (JP); Toru Umemoto, Ibaraki-shi (JP); Tadayuki Kameyama, Ibaraki-shi (JP)

(73) Assignee: NITTO DENKO CORPORATION, Ibaraki-shi, Osaka (JP)

(21) Appl. No.: 14/113,164

(22) PCT Filed: Dec. 5, 2012
(86) PCT No.: PCT/JP2012/081560

§ 371 Date: Oct. 21, 2013

(30) Foreign Application Priority Data
Dec. 9, 2011 (JP) 2011-270257

(51) Int. Cl. G02B 5/30

(52) U.S. Cl. CPC G02B 5/305
USPC 427/163.1; 427/355

(57) ABSTRACT

Provided is a method for manufacturing a long laminate film having a uniform coating layer while suppressing wrinkling of the coating receiving surface of a long film used as a base film,

the method including supporting the long film with first and second guide rolls while feeding the long film, nipping transverse both ends of the long film with a pair of nip rolls and the guide roll while feeding the long film, and applying a coating material to the long film to form a coating layer, wherein the guide roll has both end parts, which are arranged opposite to the pair of nip rolls, and a middle part other than both end parts, and both end parts have an outer diameter larger than that of the middle part.

### BACKGROUND OF THE INVENTION

1. Field of the invention

The invention relates to a method for manufacturing a long laminate film including a long film and a coating layer placed thereon.

2. Description of the Related Art

A conventionally known method for manufacturing a long laminate film includes pressing a coating head against the surface of a long film whose back surface is supported between two guide rolls and applying a coating material from the coating head to the surface of the long film to form a coating layer. It is known that if wrinkling occurs on the long film between the two guide rolls, the thickness of the coating layer can vary so that a striped appearance defect can occur (Japanese Patent No. 3080720). To solve this problem, it is proposed to arrange nip rolls at both ends of a guide roll in such a manner that the nip rolls are outwardly oriented at an angle not parallel to the film traveling direction so that a tension can be applied in the transverse direction of the film during coating (Japanese Patent No. 3080720).

Patent Document: Japanese Patent No. 3020720

### SUMMARY OF THE INVENTION

Unfortunately, according to Japanese Patent No. 3020720 wrinkling cannot be effectively suppressed when the friction between the long film and the guide roll is relatively large.

The invention has been accomplished in view of the state of the prior art, and an object of the invention is to provide a method for manufacturing a long laminate film having a uniform coating layer while suppressing wrinkling of the coating receiving surface of a long film used as a base film.

The invention is directed to a method for manufacturing a long laminate film including a long film and a coating layer placed on the long film,

the method including a coating layer forming step including applying a coating material to the long film from a coating head being pressed against the coating receiving surface of the long film being fed, while supporting the back surface of the long film with a first guide roll and a second guide roll, so that the coating layer is formed, wherein the back surface is opposite to the coating receiving surface on which the coating layer is to be formed, the second guide roll is disposed downstream of the first guide roll with respect to the direction in which the long film is fed, and the coating head is disposed between the first guide roll and the second guide roll,

the coating layer forming step further including:

nipping both transverse ends of the long film with the first guide roll and a pair of upstream nip rolls and applying, to the long film, a force in a direction to stretch the width of the long film, while feeding the long film and applying the coating material, wherein

the pair of upstream nip rolls includes a first roll and a second roll which are arranged opposite to the first guide roll and in contact with the coating receiving surface of the long film,

the rotation axes of the first and second rolls constituting the pair of upstream nip rolls intersect at a position downstream of the position of the pair of upstream nip rolls with respect to the direction in which the long film is fed, and

the first guide roll has both end parts and a middle part other than both end parts, wherein both end parts nip both ends of the long film together with the pair of upstream nip rolls, and both end parts have an outer diameter larger than that of the middle part; and/or

nipping both transverse ends of the long film with the second guide roll and a pair of downstream nip rolls in such a manner that the second guide roll and the pair of downstream nip rolls are prevented from coming into contact with the coating layer, and applying, to the long film, a force in a direction to stretch the width of the long film, while feeding the long film and applying the coating material, wherein

the pair of downstream nip rolls includes a third roll and a fourth roll which are arranged opposite to the second guide roll and in contact with the coating receiving surface of the long film,

the rotation axes of the third and fourth rolls constituting the pair of downstream nip rolls intersect at a position downstream of the position of the pair of downstream nip rolls with respect to the direction in which the long film is fed, and

the second guide roll has both end parts and a middle part other than both end parts, wherein both end parts nip both ends of the long film together with the pair of downstream nip rolls, and both end parts have an outer diameter larger than that of the middle art.

According to this feature, the pair of upstream nip rolls including the first and second rolls arranged in a truncated V shape widening toward the film traveling direction apply a force in a direction to stretch the width of the traveling long film, and/or the pair of downstream nip rolls including the third and fourth rolls arranged in a truncated V shape widening toward the film traveling direction apply a force in a direction to stretch the width of the traveling long film. In addition, the first guide roll and/or the second guide roll have/has both end parts with a small outer diameter (diameter) and a middle part with a large outer diameter (diameter) other than both end parts, in which there is a difference in diameter. This feature makes it possible to reduce the frictional force between the middle part (smaller in outer diameter) of the guide roll and the long film in contact therewith and to increase the holding pressure (nip pressure or pinch pressure) between each of both end parts (larger in outer diameter) of the guide roll and each of the pair of nip rolls, so that wrinkling can be effectively suppressed. As a result, a long laminate film having a uniform coating layer can be successfully manufactured.

In the invention, at least the downstream nip rolls are preferably arranged opposite to the second guide roll. Wrinkling can be successfully suppressed by applying a tension in the outward transverse direction to the long film on the side downstream of the coating position with respect to the traveling direction.

In the invention, the ratio of the outer diameter of both end parts of the first guide roll and/or the second guide roll to the outer diameter of the middle part other than both end parts (both end parts diameter:middle part diameter) is preferably from 100.025:100 to 125:100. When the ratio of the both end parts diameter to the middle part diameter falls within the range of 100.025:100 to 125:100, the frictional force with the long film can be reduced enough to produce the effect of suppressing wrinkling, and the long film can be prevented from slacking, so that uneven coating can be effectively suppressed.

In the invention, the rotation axis of the first guide roll and the rotation axis of the first roll preferably intersect at an acute angle (θ1) of 1° to 10°, and the rotation axis of the first guide roll and the rotation axis of the second roll preferably intersect at an acute angle (θ2) of 1° to 10°, and/or the rotation axis of the second guide roll and the rotation axis of the third roll preferably intersect at an acute angle (θ3) of 1° to 10°, and the rotation axis of the second guide roll and the rotation axis of the fourth roll preferably intersect at an acute angle (θ4) of 1° to 10°. If the intersection angle (θ1 to θ4) is smaller than 1° or larger than 10°, a force in a direction to stretch the width of the film may fail to be sufficiently applied.

In a preferred mode of the invention, the pair of upstream nip rolls simultaneously comes into contact with the long film and the first guide roll, and/or

the pair of downstream nip rolls simultaneously comes into contact with the long film and the second guide roll. This feature is preferable in that it becomes easy to apply a force uniformly in a direction to stretch the width of the film.

In an embodiment of the invention, the first, second, third, and fourth rolls each preferably have a circumference surface made of elastomer resin. The material for the circumference surface of each roll may be selected depending on the material of the long film or the surface conditions of the long film. When the long film is a plastic film, the circumference surface of each roll is more preferably made of elastomer resin in view of frictional force.

In an embodiment of the invention, the long film is preferably made of cycloolefin-based resin (cycloolefin series resin).

In an embodiment of the invention, the coating material is preferably a lyotropic liquid crystal coating material. When a lyotropic liquid crystal coating material is applied to form an optical film, uneven coating should be prevented as far as possible in view of optical properties. The manufacturing method of the invention can prevent uneven coating and thus is suitable for such optical film production.

The invention also makes it possible to use a long film as thin as about 5 μm to about 50 μm. The invention also makes it possible to use a low-viscosity coating material (for example, 50 mPa·s or less in viscosity).

### BRIEF DESCRIPTION OF THE DRAWINGS

FIGS. 1(a) and 1(b) are schematic diagrams showing a manufacturing method according to the invention;

FIG. 2 is a schematic diagram for illustrating a pair of downstream nip rolls and a second guide roll;

FIG. 3 is a schematic diagram of a long laminate film;

FIGS. 4(a) and 4(b) are schematic diagrams for illustrating a pair of upstream nip rolls and a first guide roll; and

FIG. 5 is a schematic diagram for illustrating a pair of upstream nip rolls and a first guide roll.

### DETAILED DESCRIPTION OF THE PREFERRED EMBODIMENTS

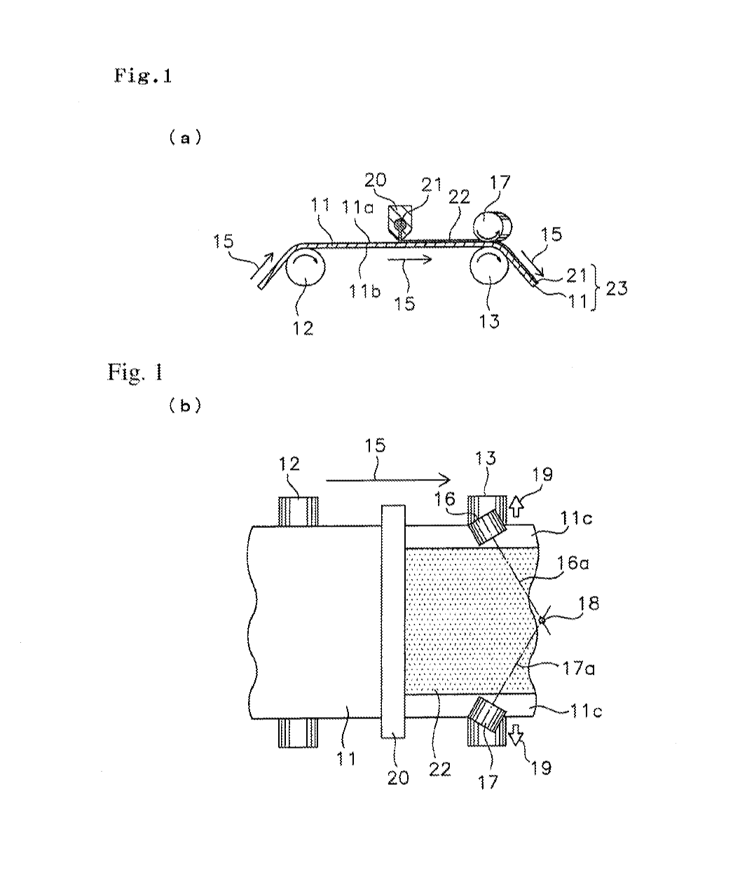

The method of the invention for manufacturing a long laminate film will be described with reference to FIGS. 1 to 5. FIGS. 1(a), 1(b) and 2 show an example of the method of the invention for manufacturing a long laminate film. The method of the invention for manufacturing a long laminate film includes a coating layer forming step as described below.

A long film 11 travels (or is being fed) in a certain direction 15 while it is supported with a first guide roll 12 and a second guide roll 13, which are upstream and downstream, respectively, with respect to the film traveling direction 15. Although not shown, feeding means are provided such as feed rolls for feeding the long film 11 and a take-up roll. In FIG. 1(a), the upper surface of the long film 11 is the coating receiving surface 11a on which a coating layer 22 is to be formed, and the lower surface of the long film 11 is the back surface 11b which is supported with each guide roll while a constant tension is applied thereto (for example, at least to such an extent that a coating head 20 can apply a coating material to the coating receiving surface 11a).

The first guide roll 12 generally has a cylindrical shape with a diameter of 20 mm to 20 mm.

As shown in FIG. 2, the second guide roll 13 has both end parts 13b and a middle part 13c, which have circular cross-sections, and the diameter of both end parts 13b differs from the diameter of the middle part 13c. The outer diameter D1 of both end parts 13b of the second guide roll 13 is larger than the outer diameter D1 of the middle part 13c, which is other than both end parts 13b. The boundary part between each of both end parts 13b and the middle part 13c may be a stepped structure as shown in FIG. 2 or may be a tapered structure. The middle part 13c preferably has a cylindrical shape with a uniform outer diameter (diameter) in the longitudinal direction of the cylinder. Alternatively, however, the middle part 13c may have different outer diameters (for example, a crown roll).

For example, when the diameter D2 of the middle part 13c is 40 mm, the diameter D1 of both end parts 13b is preferably in the range of 40.01 mm to 50 mm (both end parts diameter D1:middle part diameter D2=100.025:100 to 125:100), more preferably in the range of 40.05 mm to 45.71 mm (both end parts diameter D1:middle part diameter D2=100.125:100 to 114.275:100) even more preferably in the range of 40.1 mm to 43.24 mm (both end parts diameter D1:middle part diameter D2=100.2.5:100 to 108.1:100). Preferably, as the value range is narrowed, the effect of suppressing wrinkling can be increased.

In FIGS. 1(a) and 1(b), a pair of downstream nip rolls including a third roll 15 and a fourth roll 17 is arranged opposite to both end parts of the second guide roll 13 with the long film 11 nipped therebetween. The third roll 16 and the fourth roll 17 nip both transverse ends 11c of the coating receiving surface 11b of the film so as not to come into contact with the coating laver 22.

The third roll 16 and the fourth roll 17, which form a pair, are arranged in a truncated V shape widening toward the film traveling direction. An intersection point 18 at which the rotation axis 16a of the third roll 16 and the rotation axis 17a of the fourth roll 17 intersect with each other is downstream of the position of the pair of downstream nip rolls (downstream of the line of the rotation axis 13a of the second guide roll 13) with respect to the direction in which the long film 11 travels. When the peripheral speeds of the third roll 16 and the fourth roll 17 are set equal to the peripheral speed of the second guide roll 13, not only a force in the traveling direction 15 but also a force 19 in the transverse direction of the film are applied to the long film 11 because the rotation axes 16a and 17a of the third and fourth rolls 16 and 17 are not perpendicular to the traveling direction 15, respectively. The force 19 in the transverse direction of the film acts to stretch the width of the long film 11. Thus, the force 19 is applied in a direction to stretch the width of the traveling long film 11.

In addition, the rotation axis 13a of the second guide roll 13 and the rotation axis 16a of the third roll 16 preferably intersect at an angle (θ3) of 1° to 10°, and the rotation axis 13a of the second guide roll 13 and the rotation axis 17a of the fourth roll 17 preferably intersect at an angle (θ4) of 1° to 10°. If the intersection angle (θ3, θ4) is smaller than 1° or larger than 10°, the above effect may decrease. The intersection angle (θ3, θ4) is more preferably from 3° to 8°, even more preferably from 4° to 6°. The angles θ3 and θ4 are preferably equal to each other, but may be set different from each other depending on the condition of the long film, the traveling conditions, or various other conditions.

A coating head 20 is disposed between the first guide roll 12 and the second guide roll 13. The coating head 20 is configured to apply a coating material 21 to the coating receiving surface ha of the long film 11 traveling in the direction 15 while it is pressed against the surface 11a so that a coating layer 22 can be formed thereon. The above process makes it possible to reduce the frictional force between the middle part 13c (smaller in outer diameter) of the second guide roll 13 and the long film in contact therewith and to increase the holding pressure (nip pressure or pinch pressure) between each of both end parts 13b (larger in outer diameter) and each of the pair of downstream nip rolls (16, 17), so that the coating material 21 can be successfully applied while wrinkling is effectively suppressed. As a result, a laminate including the long film 11 and a uniform coating layer 22 formed thereon can be successfully made as a long laminate film 23.

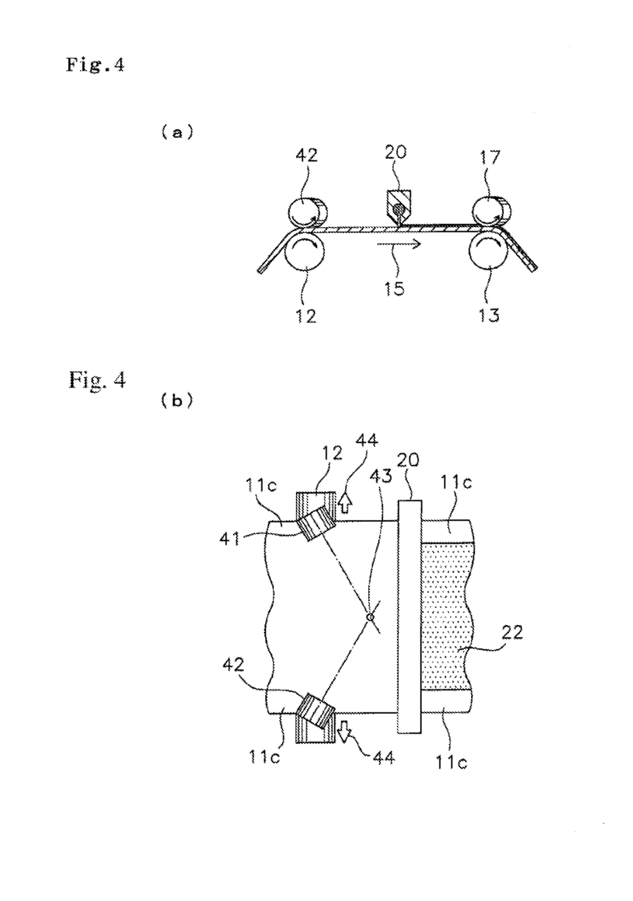

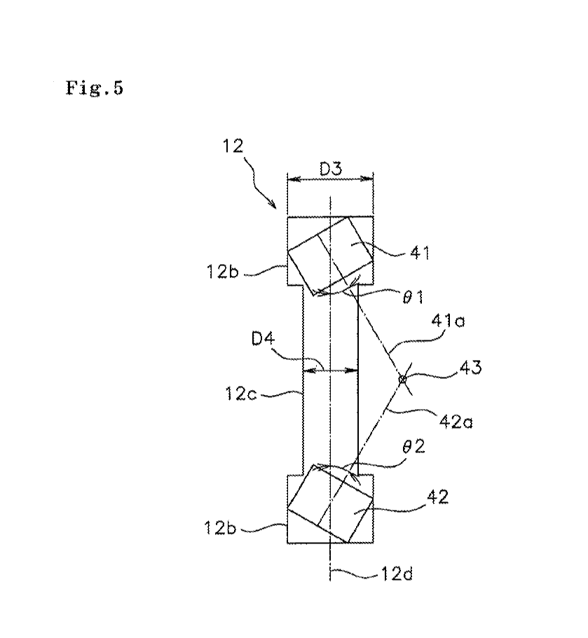

It will be understood that the invention is not limited to the use of a pair of downstream nip rolls (16, 17) in the manufacturing method and that a pair of upstream nip rolls arranged opposite to the first guide roll 12 may further be used or a pair of upstream nip rolls may only be used. FIGS. 4(a), 4(b), and 5 show a pair of upstream nip rolls (41, 42), which may be configured similarly to the pair of downstream nip rolls (16, 17). The pair of upstream nip rolls (41, 42) includes a first roll 41 and a second roll 42, which are so configured that the rotation axis 41a of the first roll 41 and the rotation axis 42a of the second roll 42 intersect at a position (point 43) downstream of the position of the pair of upstream nip rolls (downstream of the line of the rotation axis 12a of the first guide roll 12) with respect to the direction 15 in which the long film 11 travels. The pair of upstream nip rolls (41, 42) and both end parts 12b of the first guide roll 12 are configured to nip both ends 11c of the long film 11 therebetween in which the first guide roll 12 is cylindrical and the diameter D3 of both end parts 12b of the first guide roll 12 is larger than the diameter D4 of the middle part 12c of the first guide roll 12, which is other than both end parts 12b. For example, when the diameter D4 of the middle part 12b is 40 mm, the diameter D3 of both end parts 12c is preferably in the range of 40.01 mm to 50 mm (both end parts diameter P3:middle part diameter D4=100.025:100 to 125:100), more preferably in the range of 40.05 mm to 45.71 mm (both end parts diameter D3:middle part diameter D4=100.125:100 to 114.275:100), even more preferably in the range of 40.1 mm to 43.24 mm (both end parts diameter D3:middle part diameter D4=100.25:100 to 108.1:100). In addition, the rotation axis 12a of the first guide roll 12 and the rotation axis 41a of the first roll 41 preferably intersect at an angle (θ1) of 1° to 10°, and the rotation axis 12a of the first guide roll 12 and the rotation axis 42a of the second roll 42 preferably intersect at an angle (θ2) of 1° to 10°.

The method of the invention for manufacturing a long laminate film may include other steps in addition to the above step. For example, other steps include, but are not limited to, the step of subjecting the long film to a hydrophilization treatment (e.g., a corona treatment), the step of subjecting the long film to an alignment treatment (e.g., rubbing), and the step of drying the coating layer.

### (Long Film)

The long film 11 has a longitudinal length sufficiently larger than its width. Its length is preferably 10 times or more its width. The length of the long film 11 is preferably 300 m or more.

For high ability to suppress wrinkling, the thickness of the long film 11 is preferably 150 μm or less, more preferably 100 μm or less, even more preferably 50 μm or less. The lower limit of the thickness of the long film 11 is typically, but not limited to, 5 μm or more. According to the invention, a long film 11 as thin as about 5 μm to about 50 μm can also be used, which would otherwise be susceptible to wrinkling and thus be difficult to use in conventional techniques.

The long film 11 is preferably transparent. For example, the long film 11 preferably has a transmittance of 80% or more at a wavelength of 590 nm (yellow to orange).

Examples of the material used to form the long film 11 include, but are not limited to, polyester resin, cellulose resin, cycloolefin-based resin (cycloolefin series resin), acrylic resin, etc. In particular, cycloolefin-based resin (cycloolefin series resin) is preferred.

The long film 11 may be a monolayer film or a multilayer film including a monolayer film coated with a film of a polymer such as polyimide or polyvinyl alcohol.

To stabilize the traveling, a tension of 50 N to 200 N per 1 m width of film is preferably applied in the traveling direction 15 to the long film 11.

### (First and Second Guide Rolls)

As already stated, the first guide roll 12 and the second guide roll 13 are configured to support the back surface 11b of the long film 11 while the long film 11 travels. The first guide roll 12 and the second guide roll 13 (both end parts 13b) each generally have a diameter of 20 mm to 40 mm. For example, the first guide roll 12 and the second guide roll 13 are each made of aluminum, iron, stainless steel, a carbon composite material, rubber, nickel, chromium, or the like.

The distance between the axes of the first and second guide rolls 12 and 13 is preferably from 20 mm to 1,000 mm although it may be determined as desired depending on the size of the coating head 20 or the diameters of the first guide roll 12 and the second guide roll 13.

The first guide roll 12 and the second guide roll 13 may each be a drive roll connected to a driving source or a free roll that passively rotates as the long film 11 travels.

When a pair of upstream nip rolls is arranged opposite to the first guide roll 12, the first guide roll 12 may be configured as described above with reference to FIGS. 4(a), 4(b) and 5. The pair of downstream nip rolls shown in FIGS. 1(a), 1(b), and 2 and the second guide roll 13 may be used in combination with a pair of upstream nip rolls. In this case, the first guide roll 12 may be configured different from that shown in FIGS. 4(a), 4(b), and 5. For example, both end parts and the middle part of the first guide roll 12 may have the same outer diameter, or the first guide roll 12 may have a cylindrical part with a uniform outer diameter (substantially the same diameter) to be in contact with the long film.

### (Pair of Downstream Nip Rolls)

The third roll 16 and the fourth roll 17 constituting the pair of downstream nip rolls are used to feed the long film 11 while nipping both transverse ends 11c of the long film 11 between the second guide roll 13 and them. The third roll 16 and the fourth roll 17 are arranged in a truncated V shape, and their rotation axes 16a and 17a intersect at the point 18 downstream of them with respect to the direction 15 in which the long film 11 travels.

Although the third roll 16, the fourth roll 17, and the second guide roll 13 have the same peripheral speed, not only a force in the traveling direction 15 but also a force 19 in the transverse direction are applied to the long film 11 because the rotation axes 16a and 17a of the third and fourth rolls 16 and 17 are not perpendicular to the traveling direction 15. The force 19 in the transverse direction acts in a direction to stretch the width of the long film 11.

Applying the force 19 in the transverse direction to the traveling long film 11 smoothes and eliminates wrinkles formed upstream and downstream of the second guide roll 13. Specifically, wrinkles around the nip rolls disappear as the long film 11 passes between the second guide roll 13 and the third and fourth rolls 16 and 17, so that the long film 11 becomes almost free of wrinkles. When the coating material 21 is applied to the long film 11 under such conditions, a coating layer 22 with no variations in thickness can be obtained, and striped unevenness will not be observed.

The third roll 16 and the fourth roll 17 each generally have a diameter d of 10 mm to 50 mm. As shown in FIG. 1(a) and 1(b), the third roll 16 and the fourth roll 17 preferably come into contact simultaneously with both the long film 11 and the second guide roll 13. From this point of view, the third roll 16 and the fourth roll 17 should each have a somewhat large width w, which is preferably from 10 mm to 50 mm.

As a non-limiting example, the circumference surfaces of the third and fourth rolls 16 and 17 (the surfaces of the third and fourth rolls 16 and 17 to be in contact with the long film 11 and the second guide roll 13) are preferably made of elastomer resin such as styrene rubber or urethane rubber.

### (Pair of Upstream Nip Rolls)

When a pair of upstream nip rolls is used, the pair of upstream nip rolls (41, 42) may be configured as described above with reference to FIGS. 4(a), 4(b), and 5. In this case, the first roll 41 may be configured as the third roll 16, and the second roll 42 may be configured as the fourth roll 17.

### (Coating Head)

The coating head 20 used in the invention is configured to apply coating material 21 to the surface 11a of the long film 11 while it is pressed against the long film 11 so that a coating layer 22 can be formed.

The coating head 20 may be of any type capable of forming a coating layer 22. For example, a gravure coating head, a die coating head, a wire bar, or the like may be used.

The coating material 21 used in the invention preferably has a viscosity of 50 mPa·s to 5,000 mPa·s as measured with a rotational viscometer at a shearing rate of 100 s⁻¹.

According to the invention, a low-viscosity coating material 21 (for example, 50 mPa·s or less in viscosity) can also be used, which would otherwise be difficult to use in conventional techniques because it can easily flow in response to irregularities of wrinkles.

The amount in which the coating head 20 is pushed in from the initial position of the long film 11 not pushed by the coating head 20 is preferably more than 0 mm to 50 mm or less.

### (Lyotropic Liquid Crystal Coating Material)

The lyotropic liquid crystal coating material includes a solution containing a lyotropic liquid crystal compound and a solvent. The term “lyotropic liquid crystal compound” means a liquid crystal compound capable of undergoing a phase transition from an isotropic phase to a liquid crystal phase as the concentration of it dissolved in a solvent changes. When a liquid containing a lyotropic liquid crystal compound in an isotropic phase is applied to a rubbed surface or the like, the lyotropic liquid crystal compound can be oriented in a single direction. The oriented lyotropic liquid crystal compound can form an optically anisotropic film.

In the invention, the lyotropic liquid crystal compound may be of any type having the above properties. Examples of the lyotropic liquid crystal compound that may be used include azo compounds, anthraquinone compounds, perylene compounds, quinophthalone compounds, naphthoquinone compounds, or merocyanine compounds, etc. It will be understood that not only lyotropic liquid crystal compounds synthesized by common methods but also commercially available lyotropic liquid crystal compounds may be used.

The solvent in the solution may be of any type as long as the lyotropic liquid crystal compound can form an isotropic phase or a liquid crystal phase in it. For example, water, an alcohol, a cellosolve, or a mixed solvent of two or more thereof may be used.

The solution may contain an additive. For example, a surfactant, an antioxidant, an orientation aid, or any other additive may be used.

### (Coating Layer)

The coating layer obtained by the manufacturing method of the invention is preferably, but not limited to, a product obtained by spreading a solution or dispersion containing the lyotropic liquid crystal compound and the solvent, in a layer form on the surface of the long film. The coating layer preferably has a wet thickness of 1 μm to 10 μm.

In general, a coating layer containing a lyotropic liquid crystal compound must be thin and uniform so that it can have a practical level of optical properties. For this purpose, it is necessary to use a low-viscosity coating material. However, the influence of wrinkles on a long film can easily cause a low-viscosity coating material to form an uneven coating. Thus, it has been difficult for conventional manufacturing methods to form a uniform coating layer.

Using the manufacturing method of the invention, wrinkling of the long film can be effectively suppressed, so that a low-viscosity coating material can be uniformly and thinly applied. This makes it possible to form a thin, uniform coating layer.

When the coating layer contains a lyotropic liquid crystal compound, the content of the lyotropic liquid crystal compound is preferably from 0.1% by weight to 10% by weight based on the total weight of the coating layer.

Examples of the lyotropic liquid crystal compound include azo compounds, anthraquinone compounds, perylene compounds, quinophthalone compounds, naphthoquinone compounds, merocyanine compounds, etc. Any of such lyotropic liquid crystal compounds exhibit absorption dichroism in the visible light region (wavelength 380 nm to 780 nm). Thus, the coating layer containing any of such lyotropic liquid crystal compounds can be used as a polarizer.

### (Long Laminate Film)

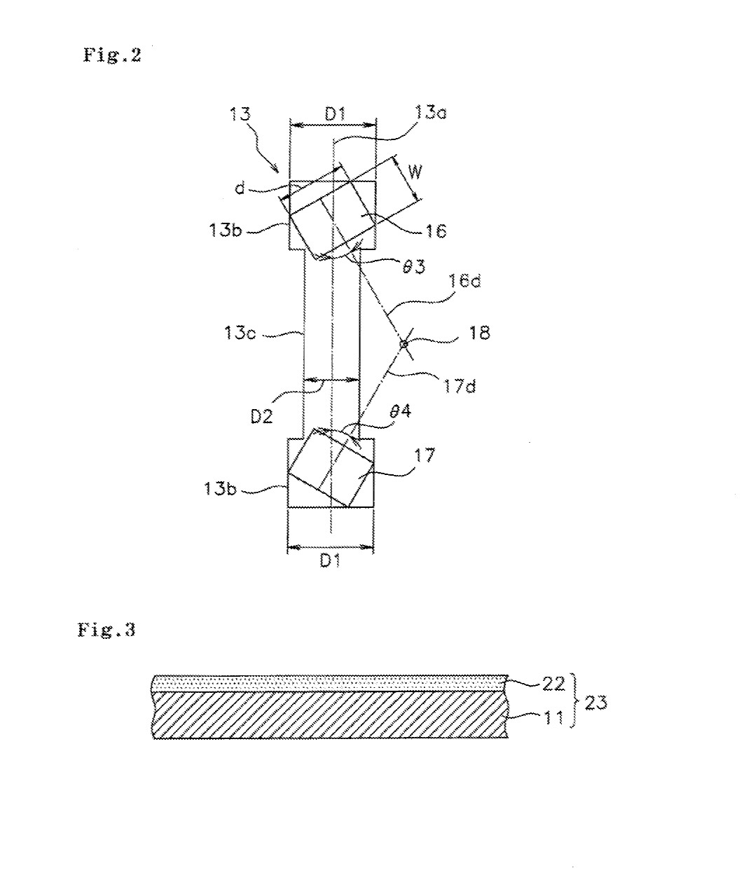

As shown in FIG. 3, the long laminate film 23 obtained by the manufacturing method of the invention includes the long film 11 and the coating layer 22 formed on its surface. The total thickness of the long laminate film 23 is preferably from 10 μm to 300 μm.

### EXAMPLES

According to a conventional method (Yutaka Hosoda, “Riron Seizo Senryo Kagaku” (Theoretical Production Dye Chemistry), Fifth Edition, published on Jul. 15, 1968, GIHODO SHUPPAN Co., Ltd., pages 135 to 152), 4-nitroaniline and 8-amino-2-naphthalenesulfonic acid were subjected to diazotization and coupling reaction to form a monoazo compound.

The monoazo compound was diazotized in the same manner as the conventional method, and the product was further subjected to a coupling reaction 1-amino-8-naphthol-2,4-disulfonate lithium salt, so that a crude product containing an azo compound of structural formula (1) below was obtained. The product was subjected to salting out with lithium chloride, so that the azo compound of structural formula (1) below was obtained.

A small amount of the azo compound was sampled and dissolved in water. As a result of polarization microscope observation, the solution showed a nematic liquid crystal phase at 20% by weight.

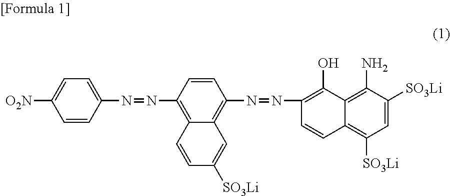

The azo compound was dissolved in ion-exchanged water to form an aqueous 5% by weight solution, which was used as a coating liquid (corresponding to the coating material 21).

### Example 1

The example was performed using the manufacturing method. shown in FIGS. 1(a), 1(b), and 2. The second guide roll 13 had a diameter of 40.0 mm at the middle part 13c along the longitudinal direction and a diameter of 40.4 mm at both end parts 13b. The third and fourth rolls 16 and 17 constituting the pair of downstream nip rolls each had a diameter d of 20 mm and a width w of 20 mm. The third and fourth rolls 16 and 17 were so arranged that the rotation axis 13a of the second guide roll 13 made an angle (θ3, θ4) of 5° with each of the rotation axes 16a and 17a of the third and fourth rolls 16 and 17. The first guide roll 12 had a diameter of 30 mm. The long film 11 used was a cycloolefin-based polymer film (ZEONOR (trade name) manufactured by ZEON CORPORATION) with a width of 440 mm and a thickness of 40 μm. The tension in the traveling direction 15 applied to the long film 11 was 100 N per 1 m of film width. During coating, the long film 11 was fed at a rate of 2 m/minute in the direction 15.

Using the coating head 20, the lyotropic liquid crystal coating liquid prepared as described above (5% in solid concentration, 1.3 mPa·s in apparent viscosity at a shearing rate of 1,000 s⁻¹) was applied at an application rate of 2 m/minute to the cycloolefin-based polymer film so that a 0.3 μm thick coating layer could be formed after drying. The apparent viscosity was based on the result of the measurement in which 0.1 cc of the liquid was sampled and measured for viscosity in the shearing rate range of 10 s⁻¹ to 2,000 s⁻¹ using a rotational viscometer (RBI manufactured by HAKKE).

### Comparative Example 1

The coating was performed under the same conditions as in Example 1, except that the pair of downstream nip rolls (16, 17) was not used.

### Comparative Example 2

The coating was performed under the same conditions as in Example 1, except that a straight guide roll 40.0 mm in diameter (with no step) was used instead as the second guide roll.

### Example 2

The coating was performed under the same conditions as in Example 1, except that a guide roll having a diameter 40.0 mm at its middle part 13c and a diameter of 40.8 mm at both end parts 13b was used instead as the second guide roll.

### Comparative Example 3

The coating was performed and the same conditions as in Example 2, except that the pair of downstream nip rolls (16, 17) was not used.

### Example 3

The coating was performed under the same conditions as in Example 1, except that a guide roll having a diameter 40.0 mm at its middle part 13c and a diameter of 43 mm at both end parts 13b was used instead as the second guide roll.

### Example 4

The coating was performed under the same conditions as in Example 1, except that a guide roll having a diameter 40.0 mm at its middle part 13c and a diameter of 40.1 mm at both end parts 13b was used instead as the second guide roll.

The long laminate film 23 obtained in each of the examples and the comparative examples was evaluated for the surface condition of the coating layer. In the evaluation, the long laminate film 23 was placed on a backlight with a brightness of 10,000 cd/m² (Flat Illuminator manufactured by Raytronics Corp.) and visually observed.

### <Evaluation Results>

Table 1 shows the results of the evaluation. As shown in Table 1, all the long laminate films obtained in Examples 1 to 4 had good coating surface conditions with no striped unevenness observed on the surface of the coating layer. In contrast, striped unevenness was observed on the surface of the coating layer of the long laminate film obtained in each of Comparative Examples 1, 7, and 3.

TABLE 1

| | | | Both end | Presence or | Coating |
|---|---|---|---|---|---|
| | | | parts | absence of | surface |
| | Diameter (mm) | Diameter (mm) | diameter: | pair of | condition |
| | of both end | of middle | middle part | downstream | (visual |
| | parts of roll | part of roll | diameter | nip rolls | observation) |
| Example 1 | 40.4 | 40.0 | 101:100 | Present | Good |
| Comparative | 40.4 | 40.0 | 101:100 | Absent | Striped |
| Example 1 | | | | | |
| Comparative | 40.0 | 40.0 | 100:100 | Present | Striped |
| Example 2 | | | | | |
| Example 2 | 40.8 | 40.0 | 102:100 | Present | Good |
| Comparative | 40.8 | 40.0 | 102:100 | Absent | Striped |
| Example 3 | | | | | |
| Example 3 | 43.0 | 40.0 | 107.5:100 | Present | Good |
| Example 4 | 40.1 | 40.0 | 100.25:100 | Present | Good |

### DESCRIPTION OF REFERENCE CHARACTERS

11 long film
11a coating receiving surface of a long film
11b back surface of a long film
11c both transverse ends of a long film
12 first guide roll
13 second guide roll
13a rotation axis of a second guide roll
13b both end parts
13c middle part
15 traveling direction
16 third roll
16a rotation axis of a third roll
17 fourth roll
17a rotation axis of a fourth roll
18 intersection point
19 a force in a transverse direction of a long film
20 coating head
21 coating material
22 coating layer
23 long laminate film

1. A method for manufacturing a long laminate film comprising a long film and a coating layer placed on the long film,
the method comprising a coating layer forming step comprising applying a coaling material to the long film from a coating head being pressed against a coating receiving surface of the long film being fed, while supporting a back surface of the long film with a first guide roll and a second guide roll, so that the coating layer is formed, wherein the back surface is opposite to the coating receiving surface on which the coating layer is to be formed, the second guide roll is disposed downstream of the first guide roll with respect to a direction in which the long film is fed, and the coating head is disposed between the first guide roll and the second guide roll,
the coating layer forming step further comprising:
nipping both transverse ends of the long film with the first guide roll and a pair of upstream nip rolls and applying, to the long film, a force in a direction to stretch the width of the long film, while feeding the long film and applying the coating material, wherein
the pair of upstream nip rolls comprises a first roll and a second roll which are arranged opposite to the first guide roll and in contact with the coating receiving surface of the long film,
rotation axes of the first and second rolls constituting the pair of upstream nip rolls intersect at a position downstream of the position of the pair of upstream nip rolls with respect to the direction in which the long film is fed, and
the first guide roll has both end parts and a middle part other than both end parts, wherein both end parts nip both ends of the long film together with the pair of upstream nip rolls, and both end parts have an outer diameter larger than that of the middle part; and/or
nipping both transverse ends of the long film with the second guide roll and a pair of downstream nip rolls in such a manner that the second guide roll and the pair of downstream nip rolls are prevented from coming into contact with the coating layer, and applying, to the long film, a force in a direction to stretch the width of the long film, while feeding the long film and applying the coating material, wherein
the pair of downstream nip rolls comprises a third roll and a fourth roll which are arranged opposite. A method for manufacturing a long laminate film comprising a long film and a coating layer placed on the long film,
the method comprising a coating layer forming step comprising applying a coating material to the long film from a coating head being pressed against a coating receiving surface of the long film being fed, while supporting a back surface of the long film with a first guide roll and a second guide roll, so that the coating layer is formed, wherein the back surface is opposite to the coating receiving surface on which the coating layer is to be formed, the second guide roll is disposed downstream of the first guide roll with respect to a direction in which the long film is fed, and the coating head is disposed between the first guide roll and the second guide roll,
the coating layer forming step further comprising:
nipping both transverse ends of the long film with the first guide roll and a pair of upstream nip rolls and applying, to the long film, a force in a direction to stretch the width of the long film, while feeding the long film and applying, the coating material, wherein
the pair of upstream nip rolls comprises a first roll and a second roll which are arranged opposite to the first guide roll and in contact with the coating receiving surface of the long film,
rotation axes of the first and second rolls constituting the pair of upstream nip rolls intersect at a position downstream of the position of the pair of upstream nip rolls with respect to the direction in which the long film is fed, and
the first guide roll has both end parts and a middle part other than both end parts, wherein both end parts nip both ends of the long film together with the pair of upstream nip rolls, and both end parts have an outer diameter larger than that of the middle part; and/or
nipping both transverse ends of the long film with the second guide roll and a pair of downstream nip rolls in such a manner that the second guide roll and the pair of downstream nip rolls are prevented from coining into contact with the coating layer, and applying, to the long film, a force in a direction to stretch the width of the long film, while feeding the long film and applying the coating material, wherein
the pair of downstream nip rolls comprises a third roll and a fourth roll which are arranged opposite to the second guide roll and in contact with the coating receiving surface of the long film,
rotation axes of the third and fourth rolls constituting the pair of downstream nip rolls intersect at a posit on downstream of the position of the pair of downstream nip rolls with respect to the direction in which the long film is fed, and
the second guide roll has both end parts and a middle part other than both end parts, wherein both end parts nip both ends of the long film together with the pair of downstream nip rolls, and both end parts have an outer diameter larger than that of the middle part.

2. The method according to claim 1, wherein the ratio of the outer diameter of both end parts of the first guide roll and/or the second guide roll to the outer diameter of the middle part other than both end parts (both end parts diameter:middle part diameter) is from 100.025:100 to 125:100.

3. The method according to claim 1, wherein the rotation axis of the first guide roll and the rotation axis of the first roll intersect at an acute angle (θ1) of 1° to 10°, and the rotation axis of the first guide roll and the rotation axis of the second roll intersect at an acute angle (θ2) of 1° to 10°, and/or
the rotation axis of the second guide roll and the rotation axis of the third roll intersect at an acute angle (θ3) of 1° to 10°, and the rotation axis of the second guide roll and the rotation axis of the fourth roll intersect at an acute angle (θ4) of 1° to 10°.

4. The method according to claim 1, wherein the pair of upstream nip rolls simultaneously comes into contact with the long film and the first guide roll, and/or
the pair of downstream nip rolls simultaneously comes into contact the long film and the second guide roll.

5. The method according to claim 1, wherein the first, second, third, and fourth rolls each have a circumference surface made of elastomer resin.

6. The method according to claim 1, wherein the long film is made of cycloolefin-based resin.

7. The method according to claim 1, wherein the coating material is a lyotropic liquid crystal coating material.
